(19) United States
(12) Patent Application Publication
(10) Pub. No.: US 2022/0384859 A1
(43) Pub. Date: Dec. 1, 2022

(54) BATTERY ASSEMBLY APPLICABLE TO ELECTRONIC VAPORIZATION DEVICE AND ELECTRONIC VAPORIZATION DEVICE

(71) Applicant: SHENZHEN SMOORE TECHNOLOGY LIMITED, Shenzhen (CN)

(72) Inventors: Zhijia LIANG, Shenzhen (CN); Zhengjun XIE, Shenzhen (CN); Zhinan MING, Shenzhen (CN); Jun LI, Shenzhen (CN); Zhaohuan ZENG, Shenzhen (CN); Pifa SHEN, Shenzhen (CN)

(21) Appl. No.: 17/825,331

(22) Filed: May 26, 2022

(30) Foreign Application Priority Data
Jun. 1, 2021 (CN) 202110609747.7

(51) Int. Cl. H01M 10/42; H01M 50/284; H01M 10/623; H01M 10/667

(52) U.S. Cl. CPC H01M 10/425; H01M 50/284; H01M 10/623; H01M 10/667

(57) ABSTRACT

A battery assembly for an electronic vaporization device includes: a battery core; a connection element; a circuit board electrically connected to the battery core by the connection element; and a heat isolation structure disposed around the circuit board, the heat isolation structure isolating the battery core from heat generated by the circuit board.

### CROSS-REFERENCE TO PRIOR APPLICATION

Priority is claimed to Chinese Patent Application No. CN 202110609747.7, filed on Jun. 1, 2021, the entire disclosure of which is hereby incorporated by reference herein.

### FIELD

The present invention relates to the field of electronic vaporization devices, and in particular, to a battery assembly applicable to an electronic vaporization device and an electronic vaporization device.

### BACKGROUND

In an existing electronic vaporization device, charging and discharging currents of a battery core are small, the battery core produces less heat during use, and the requirements for temperature detection of the battery core and for an ambient temperature of the battery core are not high.

The charging speed of the existing electronic vaporization device is slow, and it generally takes more than an hour to be fully charged. Therefore, there is a growing demand for battery core fast charging technology. Due to the large charging current of the battery core fast charging technology, the amount of heat generated in a charging process by a vaporization equipment is large. However, a usage specification of the battery core requires that the ambient temperature cannot exceed 45° C. In the original structural scheme, due to a large amount of heat generated by a circuit board component, the generated heat cannot be quickly dissipated, resulting in an excessively high ambient temperature inside the battery core. The high temperature of the battery core causes reduction or termination of the charging current, which affects the use of a fast charging function.

### SUMMARY

In an embodiment, the present invention provides a battery assembly for an electronic vaporization device, comprising: a battery core; a connection element; a circuit board electrically connected to the battery core by the connection element; and a heat isolation structure disposed around the circuit board, the heat isolation structure being configured to isolate the battery core from heat generated by the circuit board.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a structural schematic diagram of a first embodiment of a battery assembly according to the present invention;

FIG. 2 is a cross-sectional view of the first embodiment of the battery assembly shown in FIG. 1 taken along an A-A direction;

FIG. 3 is a cross-sectional view of a second embodiment of the battery assembly shown in FIG. 1 taken along an A-A direction; and

FIG. 4 is a structural schematic diagram of an embodiment of an electronic vaporization device according to the present invention.

### DETAILED DESCRIPTION

In an embodiment, the present invention provides a battery assembly applicable to an electronic vaporization device and an electronic vaporization device, in which a circuit board is isolated from a battery core to reduce heat transferred from the circuit board to the battery core, so that the ambient temperature of a surface of the battery core is lower than a specification temperature, thereby not affecting the charging speed.

In an embodiment, the present invention provides a battery assembly applicable to an electronic vaporization device, including: a battery core; a circuit board, electrically connected to the battery core by a connection element; and a heat isolation structure, disposed around the circuit board to isolate heat generated by the circuit board from the battery core.

The heat isolation structure covers at least two opposite surfaces of the circuit board, or is disposed around the circuit board along an axial direction of the battery assembly.

The battery assembly further includes a bracket and a sealing cover, the bracket and the sealing cover cooperating to form the heat isolation structure.

The bracket includes a first accommodating groove, the circuit board is located in the first accommodating groove, and the sealing cover covers the first accommodating groove to form the heat isolation structure.

The first accommodating groove is a blind groove; the bracket further includes a second accommodating groove spaced from the first accommodating groove, and a common sidewall is provided between the first accommodating groove and the second accommodating groove; and the battery core is located in the second accommodating groove.

The sealing cover is located on a side of the circuit board away from the bottom of the first accommodating groove, and covers an entire port of the first accommodating groove, to completely isolate the circuit board from the battery core.

The battery assembly further includes: a silicone cover, located in the first accommodating groove, located between the circuit board and the sealing cover, and cooperating with the circuit board and the sealing cover to form the heat isolation structure.

The common sidewall has an opening, and the connection element is a wire. One end of the wire is electrically connected to the battery core, and the other end is electrically connected to the circuit board through the opening.

A cross-sectional area of the opening is less than 30% of a cross-sectional area of the battery core.

The amount of heat of components of the circuit board close to the opening is less than the amount of heat of components away from the opening.

The connection element is a metal elastic piece embedded in a sidewall of the bracket. One end of the metal elastic piece extends into the first accommodating groove to be electrically connected to the circuit board, and the other end of the metal elastic piece extends out of the first accommodating groove to be electrically connected to the battery core.

In order to resolve the above technical problems, a second technical solution provided by the present invention is to provide an electronic vaporization device, including: a vaporizer; and a battery assembly, configured to supply power to the vaporizer, and including the battery assembly according to any one of the above.

Regarding the beneficial effect of the present invention, different from the related art, in the battery assembly provided in the present invention, the circuit board is isolated from the battery core by arranging the heat isolation structure around the circuit board, to reduce heat transferred from the circuit board to the battery core, so that the ambient temperature of a surface of the battery core is lower than a specification temperature, thereby not affecting the charging speed.

The technical solutions in the embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

The terms “first”, “second”, and “third” in this application are only used for descriptive purposes and are not to be construed as indicating or implying relative importance or implicitly indicating the number of technical features indicated. Therefore, features defining “first”, “second”, and “third” can explicitly or implicitly include at least one of the features. In description of this application, “multiple” means at least two, such as two and three unless it is specifically defined otherwise. All directional indications (for example, up, down, left, right, front, back) in the embodiments of this application are only used for explaining relative position relationships, movement situations or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, method, system, product, or device that includes a series of steps or units is not limited to the listed steps or units, but further optionally includes a step or unit that is not listed, or further optionally includes another step or unit that is intrinsic to the process, method, product, or device.

Embodiment mentioned in the specification means that particular features, structures, or characteristics described with reference to the embodiment may be included in at least one embodiment of this application. The term appearing at different positions of the specification may not refer to the same embodiment or an independent or alternative embodiment that is mutually exclusive with another embodiment. A person skilled in the art explicitly or implicitly understands that the embodiments described in the specification may be combined with other embodiments.

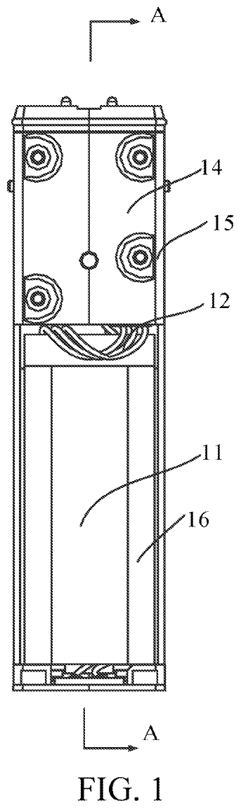

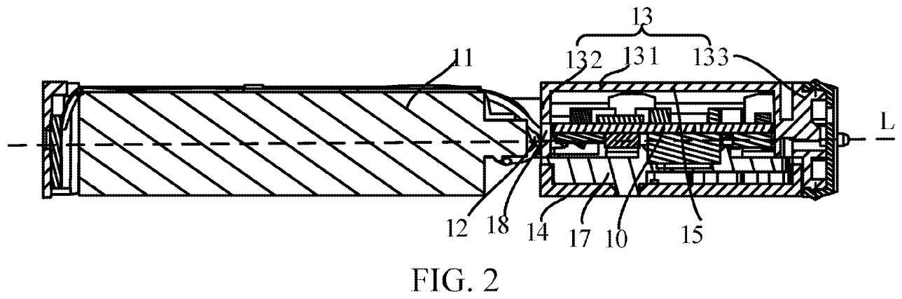

Referring to FIG. 1 and FIG. 2, FIG. 1 is a structural schematic diagram of a first embodiment of a battery assembly according to the present invention; the battery assembly shown in this embodiment being applicable to an electronic vaporization device. FIG. 2 is a cross-sectional view of the first embodiment of the battery assembly shown in FIG. 1 taken along an A-A direction. Specifically, the battery assembly includes a battery core 11 and a circuit board 10, the circuit board 10 being connected to the battery core 11 by a connection element 12. Specifically, the connection element 12 is an electrode lead drawn from the battery core 11. In a specific embodiment, an electrode tab is disposed on the battery core 11, a pad is disposed on the circuit board 10. One end of the connection element 12 is connected to the electrode tab to connect to the battery core 11, and the other end is connected to the pad to connect to the circuit board 10, so that the battery core 11 is electrically connected to the circuit board 10.

In order to reduce heat transferred from the circuit board 10 to the battery core 11 so that the ambient temperature of a surface of the battery core 11 is lower than a specification temperature, thereby not affecting the charging speed, the battery assembly of this application further arranges a heat isolation structure around the circuit board 10, to form heat isolation between the circuit board 10 and the battery core 11, and reduce the heat transferred from the circuit board 10 to the battery core 11, so that the ambient temperature of a surface of the battery core 11 is lower than a specification temperature thereby not affecting the charging speed. In a specific embodiment, the heat isolation structure covers at least two opposite surfaces of the circuit board 10, or is disposed around the circuit board 10 along an axial direction L of the battery assembly.

Specifically, referring to FIG. 2, the battery assembly further includes a bracket 15 and a sealing cover 14, the bracket 15 cooperating with the sealing cover 14 to form the heat isolation structure. Specifically, the bracket 15 includes a first accommodating groove 13 and a second accommodating groove 16. The circuit board 10 is located in the first accommodating groove 13, and the battery core 11 is located in the second accommodating groove 16. The first accommodating groove 13 is a blind groove or a blind hole, including a bottom wall 131 and an annular sidewall. The annular sidewall includes a first sidewall 132 and a second sidewall 133 disposed oppositely. The first sidewall 132 is disposed close to the second accommodating groove 16, the sealing cover 14 covers the first accommodating groove 13 on an opposite side of the bottom wall 131 of the first accommodating groove 13, that is, the sealing cover 14 covers the first accommodating groove 13 on a side of the circuit board 10 away from the bottom wall 131 of the first accommodating groove 13, thereby forming the heat isolation structure, to encapsulate the circuit board 10 in the first accommodating groove 13. Specifically, the sealing cover 14, the bottom wall 131 of the first accommodating groove 13, and the annular sidewall together form the heat isolation structure. The heat isolation structure is disposed around the circuit board 10, and can wrap the circuit board 10 to isolate the circuit board 10 from the battery core 11. In this way, the heat transferred from the circuit board 10 to the battery core 11 can be reduced, so that the ambient temperature of a surface of the battery core 11 is lower than a specification temperature, thereby not affecting the charging speed. Further, the sealing cover 14 covers an entire port of the first accommodating groove 13 on the side of the circuit board 10 away from the bottom wall 131 of the first accommodating groove 13, thereby completely isolating the circuit board 10 from the battery core 11, so that heat isolation is formed between the circuit board 10 and the battery core 11.

Further, the battery assembly further includes a silicone cover 17. The silicone cover 17 is located in the first accommodating groove 13 and located between the circuit board 10 and the sealing cover 14. The silicone cover 17 can enhance the sealability of the heat isolation structure, form the heat isolation structure in cooperation with the first accommodating groove 13 and the sealing cover 14 to encapsulate the circuit board 10, to prevent the heat generated by the circuit board 10 from being radiated to the battery core 11. The size and thickness of the silicone cover 17 are unlimited, and in an embodiment, the silicone cover 17 covers the entire circuit board 10 and has a thickness equal to a distance between the circuit board 10 and the sealing cover 14.

Further, a common sidewall is provided between the first accommodating groove 13 and the second accommodating groove 16, and the common sidewall is the first sidewall 132 of the first accommodating groove 13. The common sidewall (the first sidewall 132) has an opening 18, which may be a notch located on the common sidewall and may also be a through hole penetrating through the common sidewall. The connection element 12 is a wire, one end of the wire is electrically connected to the battery core 11, and the other end is electrically connected to the circuit board 10 through the opening 18.

In an embodiment, in order to reduce heat transferred from the circuit board 10 to the battery core 11 so that the ambient temperature of a surface of the battery core 11 is lower than a specification temperature, thereby not affecting the charging speed, a cross-sectional area of the opening 18 is less than 30% of a cross-sectional area of the battery core 11, and for example, the cross-sectional area of the opening 18 is less than 15% of the cross-sectional area of the battery core 11.

In another embodiment, in order to reduce heat transferred from the circuit board 10 to the battery core 11 so that the ambient temperature of a surface of the battery core 11 is lower than a specification temperature, thereby not affecting the charging speed, the amount of heat of components of the circuit board 10 close to the opening 18 is less than the amount of heat of components away from the opening 18, that is, a side of the circuit board 10 with less heat of the component is disposed close to the opening 18, and a side with great heat is disposed close to the second sidewall 133.

In the battery assembly according to this embodiment, the heat isolation structure is formed by the bottom wall 131, the first sidewall 132, and the second sidewall 133 of the first accommodating groove 13 in cooperation with the silicone cover 17 and the sealing cover 14, and the circuit board 10 is half-encapsulated in the first accommodating groove 13. The first sidewall 132 has the opening 18, through which the connection element 12 passes to connect the battery core 11 to the circuit board 10. In this way, heat transferred from the circuit board 10 to the battery core 11 can be reduced, so that the ambient temperature of a surface of the battery core 11 is lower than a specification temperature, thereby not affecting the charging speed.

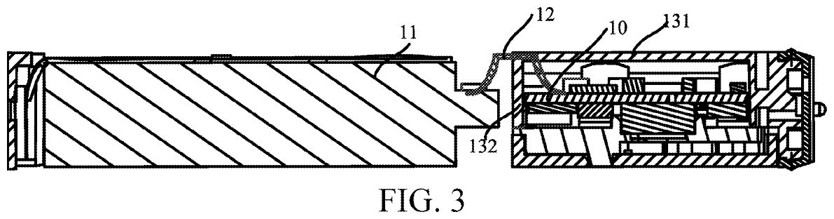

Referring to FIG. 3, FIG. 3 is a cross-sectional view of a second embodiment of the battery assembly shown in FIG. 1 taken along an A-A direction. This embodiment is different from the embodiment shown in FIG. 2 in that no opening 18 is disposed at the first sidewall 132 of the first accommodating groove 13. Specifically, the heat isolation structure is formed by the bottom wall 131 of the first accommodating groove 13 and the annular sidewall in cooperation with the silicone cover 17 and the sealing cover 14, and the circuit board 10 is completely encapsulated in the first accommodating groove 13. In this embodiment, in order to realize the electrical connection between the circuit board 10 and the battery core 11, the connection element 12 is a metal elastic piece embedded in a sidewall of the bracket 15. Specifically, as shown in FIG. 3, the connection element 12 may be embedded in the bottom wall 131 of the first accommodating groove 13, and specifically, the metal elastic piece can be disposed in a wall of the bottom wall 131 of the first accommodating groove 13 by injection molding.

One end of the metal elastic piece extends into the first accommodating groove 13 to be electrically connected to the circuit board 10, and the other end extends out of the first accommodating groove 13 to be electrically connected to the battery core 11. Specifically, the other end of the metal elastic piece may extend directly into the second accommodating groove 16 to be electrically connected to the battery core 11; alternatively, the other end of the metal elastic piece may extend between the first accommodating groove 13 and the second accommodating groove 16 to be connected to bare electrode tabs of the battery core 11, which is not specifically limited. Because the metal elastic piece is elastic and the main body part is embedded in the sidewall of the bracket 15, an end portion of the metal elastic piece elastically abuts against the electrode tab of the battery core 11 or the pad on the circuit board 10, which can simplify the assembly process of the battery assembly.

In the battery assembly according to this embodiment, the heat isolation structure is formed by the bottom wall 131, the first sidewall 132, and the second sidewall 133 of the first accommodating groove 13 in cooperation with the silicone cover 17 and the sealing cover 14, and the circuit board 10 is completely encapsulated in the first accommodating groove 13. The connection element 12 is a metal elastic piece embedded in the sidewall of the bracket 15, one end of the metal elastic piece extends into the first accommodating groove 13 to be electrically connected to the circuit board 10, and the other end extends out of the first accommodating groove 13 to be electrically connected to the battery core 11. In this way, heat transferred from the circuit board 10 to the battery core 11 can be reduced, so that the ambient temperature of a surface of the battery core 11 is lower than a specification temperature, thereby not affecting the charging speed.

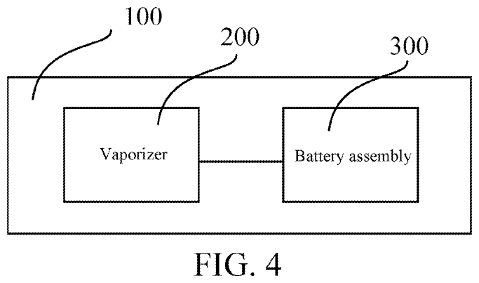

Referring to FIG. 4, FIG. 4 is a structural schematic diagram of an embodiment of an electronic vaporization device according to the present invention. Specifically, an electronic vaporization device 100 includes a vaporizer 200 and a battery assembly 300. The battery assembly 300 is configured to supply power to the vaporizer 200, and the battery assembly 300 includes the battery assembly 300 shown in any of the foregoing embodiments in FIG. 1 to FIG. 3.

The foregoing descriptions are merely implementations of the present invention but are not intended to limit the patent scope of the present invention. All equivalent structure or process changes made according to the content of this specification and accompanying drawings in the present invention or by directly or indirectly applying the present invention in other related technical fields shall fall within the protection scope of the present invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A battery assembly for an electronic vaporization device, comprising:
a battery core;
a connection element;
a circuit board electrically connected to the battery core by the connection element; and
a heat isolation structure disposed around the circuit board, the heat isolation structure being configured to isolate the battery core from heat generated by the circuit board.

2. The battery assembly of claim 1, wherein the heat isolation structure covers at least two opposite surfaces of the circuit board, or is disposed around the circuit board along an axial direction of the battery assembly.

3. The battery assembly of claim 2, wherein the heat isolation structure comprises a bracket and a sealing cover, the bracket and the sealing cover cooperating to form the heat isolation structure.

4. The battery assembly of claim 3, wherein the bracket comprises a first accommodating groove,
wherein the circuit board is located in the first accommodating groove, and
wherein the sealing cover covers the first accommodating groove to form the heat isolation structure.

5. The battery assembly of claim 4, wherein the first accommodating groove comprises a blind groove,
wherein the bracket further comprises a second accommodating groove spaced from the first accommodating groove,
wherein a common sidewall is provided between the first accommodating groove and the second accommodating groove, and
wherein the battery core is located in the second accommodating groove.

6. The battery assembly of claim 5, wherein the first accommodating groove comprises a port,
wherein the sealing cover is located on a side of the circuit board away from a bottom of the first accommodating groove, and
wherein the sealing cover covers the port of the first accommodating groove so as to isolate the circuit board from the battery core.

7. The battery assembly of claim 6, further comprising:
a silicone cover located in the first accommodating groove and between the circuit board and the sealing cover,
wherein the silicone cover cooperates with the circuit board and the sealing cover to form the heat isolation structure.

8. The battery assembly of claim 5, wherein the common sidewall has an opening, and
wherein the connection element comprises a wire, one end of the wire being electrically connected to the battery core, and an other end being electrically connected to the circuit board through the opening.

9. The battery assembly of claim 8, wherein a cross-sectional area of the opening is less than 30% of a cross-sectional area of the battery core.

10. The battery assembly of claim 8, wherein an amount of heat of components of the circuit board close to the opening is less than an amount of heat of components away from the opening.

11. The battery assembly of claim 5, wherein the connection element comprises a metal elastic piece embedded in a sidewall of the bracket, and
wherein one end of the metal elastic piece extends into the first accommodating groove to be electrically connected to the circuit board, and an other end of the metal elastic piece extends out of the first accommodating groove to be electrically connected to the battery core.

12. An electronic vaporization device, comprising:
a vaporizer; and
the battery assembly of claim 1, the battery assembly being configured to supply power to the vaporizer.
